(19) United States
(12) Patent Application Publication
(10) Pub. No.: US 2025/0043168 A1
(43) Pub. Date: Feb. 6, 2025

(54) DRILLING FLUID

(71) Applicant: Ascend Performance Materials Operations LLC, Houston, TX (US)

(72) Inventors: Salar Afra, College Station, TX (US); Hamidreza Samouei, College Station, TX (US); Hisham Nasr-El-Din, College Station, TX (US); Zheng Chai, Houston, TX (US); Jefferson Thomas Ebert, Houston, TX (US); Benjamin Haseltine, Houston, TX (US)

(73) Assignee: Ascend Performance Materials Operations LLC, Houston, TX (US)

(21) Appl. No.: 18/923,223

(22) Filed: Oct. 22, 2024

Related U.S. Application Data
(63) Continuation of application No. 17/522,388, filed on Nov. 9, 2021.
(60) Provisional application No. 63/113,417, filed on Nov. 13, 2020.

(51) Int. Cl. C09K 8/32; C09K 8/36

(52) U.S. Cl. CPC C09K 8/32; C09K 8/36

(57) ABSTRACT

Disclosed herein are drilling fluid compositions suitable for use, for example, in drilling a well bore through a subterranean formation and other oil and gas operations. The drilling fluid compositions of the present disclosure include the condensation product of a trifunctional amine and a fatty acid and an oil base fluid. The present disclosure also described processes for preparing drilling fluid compositions.

### CROSS-REFERENCE

This application is related to and claims priority to U.S. Provisional Patent Application No. 63/113,417 filed Nov. 13, 2020, which is incorporated herein by reference.

### FIELD

The present disclosure relates generally to drilling fluid compositions, e.g., for use in drilling a wellbore through a subterranean formation, and to processes for preparing drilling fluid compositions. In particular, the drilling fluid compositions described herein include a condensation product of a trifunctional amine and a fatty acid and demonstrate improved rheological performance and stability of the emulsified drilling mud.

### BACKGROUND

In various oil and gas operations, drilling fluid (also known as drilling mud) is typically used to aid in the drilling of boreholes (e.g., wellbores) into the earth. For example, drilling fluids are often used in the drilling of oil and/or natural gas well as well as for exploration drilling. When used, the drilling fluid is typically pumped from the surface to the wellbore, often with various additives, such as coolants and stabilizers. In this way, the drilling fluid carries drill cuttings from the wellbore to the surface, cools and lubricates the components of the drill string (e.g., the drill bit), and provides hydrostatic pressure so that fluids from the rock formation do not enter the wellbore. Drilling fluids can also be used to suspend the drill cuttings in the drilling mud when drilling stops. Furthermore, the drilling fluid may be incorporated into the operation of various downhole tools, such as mud pulse telemetry for transmitting information through the wellbore.

Drilling fluids are widely considered critical for successful drilling operations, and improvements in drilling fluid have contributed to improvement in drilling. Drilling deeper, longer, and more challenging wells, is now possible because of improvements in drilling technologies, such as using more efficient drilling fluids. Often, the drilling fluid used in a given drilling operation is selected for the work to be done by the fluid, the conditions of the wellbore, and the ability to limit corrosion and damage to the formation.

Drilling fluids can be classified in several ways, but often turn on the composition of the drilling fluid. For example, drilling fluids may be defined as a “water-based mud” or an “oil-based mud.” The different compositions often correlate to differences in performance characteristics. Water-based muds, for example, are often free flowing when pumped and gels when at rest in order to suspend drill cuttings and resist pumping. Oil-based mud contain an organic base fluid, such as a petroleum product (e.g., diesel fuel). Oil-based mud typically exhibit increased lubricity and reduced viscosity for these oil-based fluid systems. Furthermore, the oil-based mud can often withstand greater heat without degradation. Also, oil-based mud can be used in the formation containing water sensitive clay contents.

Regardless of classification, drilling fluids generally contain a dispersion of oil and water in combination with various additives to maintain the dispersion. For example, emulsifiers, wetting agents, and gellants can be used to control stability, viscosity, coolant, and lubrication of an oil-based drilling fluid system. Emulsifiers, in particular, are integral to the stability of drilling fluids, especially oil-based muds. The stability of the oil-based drilling muds typically relates to preventing the separation of the fluid into two layers, an aqueous layer, and an organic layer. Without a suitable emulsifier, an oil-based mud may readily phase separate and require rigorous mixing before being usable in a drilling operation.

There exists a need for a drilling fluid that is sufficiently stable and also demonstrates suitable performance characteristics (e.g., rheological performance) for use in drilling operations.

### SUMMARY

The disclosure is related to drilling fluid composition, comprising: from 0.1 wt. % to 10 wt. % of a condensation product of a trifunctional amine that may comprise from 6 to 12 carbon atoms, and a fatty acid that may comprises palmitic acid, oleic acid, linoleic acid, abictic acid, sapienic acid, palmitoleic acid, myristoleic acid, claidic acid, vaccenic acid, or tall oil, isomers thereof, or combinations thereof, e.g., a compound of formula 1 or 2a or 2b, wherein the weight ratio of the trifunctional amine to the fatty acid in the condensation product ranges from 0.1:1 to 10:1, e.g., from 0.3:1 to 2:1; and an oil base fluid, which may be a diesel oil, a mineral oil, a linear olefin, or a linear paraffin, or combinations thereof. The drilling fluid composition may demonstrate a plastic viscosity greater than 15 cP at 25° C. and/or a plastic viscosity greater than 10 cP at 80° C., and/or a yield point greater than 15 lb/100 ft² at 25° C., and/or a yield point greater than 10 lb/100 ft² at 80° C., and/or a ratio of yield point to plastic viscosity less than 2. The drilling fluid composition may further comprise a viscosity modifier, a pH modifier, a density modifier, a filtration modifier, an aqueous component, a shale inhibitor, or combinations thereof. The trifunctional amine may have a chemical formula CₓH_{y}(NH₂)₃, wherein x is from 6 to 12; and wherein y is less than or equal to 23.

The disclosure also relates to a process for preparing a drilling fluid composition, comprising: reacting a trifunctional amine and a fatty acid at a temperature of at least 100° C. for at least 10 hours to form a condensation product; and adding the condensation product to an oil base fluid to form the drilling fluid composition; wherein the condensation product comprises less than 15 wt. % impurities.

The process may further comprise the step of adding a viscosity modifier, a pH modifier, a density modifier, a filtration modifier, an aqueous component, a shale inhibitor, or combinations thereof to the oil base fluid. The oil base fluid and the trifunctional amine and the fatty acid may be as descrived above

### BRIEF DESCRIPTION OF THE DRAWINGS

The present disclosure is described in detail below with reference to the appended drawings, wherein like numerals designate similar parts.

FIG. 1 shows ¹H NMR spectra of (a) a condensation product, (b) a fatty acid reagent, and (c) a trifunctional amine, according to an embodiment of the present disclosure.

### DETAILED DESCRIPTION

### Introduction

As noted above, conventional drilling fluids, particularly oil-based muds, comprise dispersion of oil and water. To be useful in drilling operations, the drilling fluids must be sufficiently stable to resist phase separation, e.g., into an aqueous (water) layer and an organic (oil) layer. The stability of a drilling fluid may be improved by the addition of an emulsifier, such as polyaminated fatty acids, aliphatic amines, and organic polymers. However, these conventional emulsifiers suffer from performance problems, especially at high temperatures.

The inventors have now found that a condensation reaction of a trifunctional amine and a fatty acid yields a condensation product that demonstrates superior emulsion performance. For example, the condensation product may ensure the stability of a synthetic emulsion for several hours (e.g., at least 2 hours, at least 4 hours, at least 10 hours, or at least 24 hours). Importantly, the inventors have found that, in some embodiments, the weight ratio of the trifunctional amine to the fatty acid may contribute to the emulsification properties of the condensation product.

Beneficially, the disclosed condensation products may be formed using a production process that does not require complex synthesis pathways, which contributes to overall process simplicity and efficiency. Also, the production process avoids the need for environmentally-unfriendly reactants, which provides for additional process and safety benefits.

As such, the present disclosure relates to drilling fluids comprising a condensation product described herein as an emulsifier. In particular, some embodiments of the present disclosure relate to a drilling fluid composition, comprising from 0.1 wt. % to 10 wt. % of a condensation product of a trifunctional amine and a fatty acid, wherein the weight ratio of the trifunctional amine to the fatty acid in the condensation product ranges from 0.1:1 to 10:1; and an oil base fluid. Furthermore, some embodiments of the present disclosure related to the preparation of such drilling fluid compositions. As detailed below, the drilling fluid compositions beneficially exhibit improved stability as well as improved plastic viscosities and yield points.

### Trifunctional Amine

The condensation product of the present disclosure is formed by reacting a trifunctional amine and a fatty acid. The trifunctional amine comprises an organic compound having at least three amino functional groups, e.g., three amino functional groups, four amino functional groups, five amino functional groups, six amino functional groups, or seven amino functional groups. In some embodiments of the drilling fluid composition, the trifunctional amine comprises a combination of two or more such compounds.

Each amino functional group of the trifunctional amine may be subcategorized as a primary (or 1º) amine, a secondary (or 2º) amine, or tertiary (or 3º) amine. In some embodiments, the amino groups of the trifunctional amine may be of differing subcategories. In some embodiments, for example, the trifunctional amine may have a primary amino functional group, a secondary amino functional group, and a tertiary amino functional group. The trifunctional amino has at least one primary amino functional groups, e.g., at least two primary amino functional groups or at least three primary amino functional groups. Unlike amines used in conventional drilling fluids, such as DETA, in some embodiments, all the amino functional groups of the trifunctional amine are primary.

As organic compounds, the trifunctional amine of the present disclosure necessarily comprises at least one carbon atom. In some embodiments, the trifunctional amine comprises from 6 to 12 carbon atoms, e.g., from 6 to 11 carbon atoms, from 6 to 10 carbon atoms, from 7 to 12 carbon atoms, from 7 to 11 carbon atoms, from 7 to 10 carbon atoms, from 8 to 12 carbon atoms, from 8 to 11 carbon atoms, from 8 to 10 carbon atoms from 9 to 12 carbon atoms, from 9 to 11 carbon atoms, or from 9 to 10 carbon atoms. In terms of lower limits, the trifunctional amine may comprise at least 6 carbon atoms, e.g., at least 7 carbon atoms, at least 8 carbon atoms, or at least 9 carbon atoms. In terms of upper limits, the trifunctional amine may comprise less than 12 carbon atoms, e.g., less than 11 carbon atoms, or less than 10 carbon atoms.

The organic structure of the trifunctional amine is not particularly limited. In some embodiments, the trifunctional amine may be saturated. In other embodiments, the trifunctional amine may be unsaturated, e.g., an alkene or alkyne as the base hydrocarbon (base aliphatic chain). In some embodiments, the trifunctional amine may be mono-unsaturated or poly-unsaturated, e.g., as a cumulated diene, conjugated diene, or unconjugated diene. In some embodiments, the trifunctional amine may be comprise an open-chain compound, a straight-chain compound, a branched-chain compound, a cyclic compound, or a combination of these.

In some embodiments, the trifunctional amine of the present disclosure may have the following chemical formula:

CₓC_{y}(NR′R″)₃.

In one embodiment, x in the chemical formula is from 6 to 12, e.g., from 6 to 11, from 6 to 10, from 7 to 12, from 7 to 11, from 7 to 10, from 8 to 12, from 8 to 11, from 8 to 10 from 9 to 12, from 9 to 11, or from 9 to 10. In terms of lower limits, x may be at least 6, e.g., at least 7, at least 8, or at least 9. In terms of upper limits, x may be less than 12, e.g., less than 11, or less than 10.

In one embodiment, y in the chemical formula is from 3 to 23, e.g., from 4 to 23, from 5 to 23, from 6 to 23, from 3 to 22, from 4 to 22, from 5 to 22, from 6 to 22, from 3 to 21, from 4 to 21, from 5 to 21, from 6 to 21, from 3 to 20, from 4 to 20, from 5 to 20, from 6 to 20, from 3 to 23, from 4 to 23, from 5 to 23, from 6 to 23, from 3 to 18, from 4 to 18, from 5 to 18, or from 6 to 18. In terms of upper limits, y may be 23 or less, e.g., 22 or less, 21 or less, 20 or less, 19 or less, or 18 or less. In terms of lower limits, y may be at least 3, e.g., at least 4, at least 5, or at least 6.

In the chemical formula, R′and R″ each may be a hydrogen or an alkyl group of 1 to 6 carbon atoms. In some embodiments, R′ and R″ are different structure. In some embodiments, for example, R′is hydrogen and R″ is an alkyl group of less than 6 carbon atoms, e.g., less than 5 carbon atoms, less than 4 carbon atoms, or less than 3 carbon atoms. In some embodiments, R′ and R″ are the same structure. In some embodiments, for example both R′ and R″ are hydrogen.

Examples of suitable trifunctional amines include, without limitation, triaminohexane, triaminoheptane, triaminooctane, triaminononane, triaminodecane, triaminoundecane, triaminododecane, triaminocyclohexane, triaminocycloheptane, triaminocyclooctane, triaminocyclononane, triaminocyclodecane, triaminocycloundecane, triaminocyclododecane, triaminohexene, triaminoheptene, triaminooctene, triaminononene, triaminodecene, triaminoundecene, triaminododecene, tetraaminohexane, tetraaminoheptane, tetraaminooctane, tetraaminononane, tetraaminodecane, tetraaminoundecane, tetraaminododecane, tetraaminocyclohexane, tetraaminocycloheptane, tetraaminocyclooctane, tetraaminocyclononane, tetraaminocyclodecane, tetraaminocycloundecane, tetraaminocyclododecane, tetraaminohexene, tetraaminoheptene, tetraaminooctene, tetraaminononene, tetraaminodecene, tetraaminoundecene, tetraaminododecene, or isomers thereof, or combinations thereof.

One example of a commercially available trifunctional amine suitable for the drilling fluid composition is Hexatran™ by Ascend Performance Materials.

### Fatty Acid

The condensation reaction also utilizes a fatty acid as a reactant. The fatty acid comprises an organic compound having both a carboxylic acid functional group (COOH) and an aliphatic chain. In some embodiments of the drilling fluid composition, the fatty acid comprises a combination of two or more such compounds.

The fatty acid of the drilling fluid composition is not particularly limited. In one embodiment, the fatty acid comprises from 8 to 24 carbon atoms, e.g., from 9 to 24 carbon atoms, from 10 to 24 carbon atoms, from 11 to 24 carbon atoms, from 12 to 24 carbon atoms, from 13 to 24 carbon atoms, from 14 to 24 carbon atoms, from 8 to 23 carbon atoms, from 9 to 23 carbon atoms, from 10 to 23 carbon atoms, from 11 to 23 carbon atoms, from 12 to 23 carbon atoms, from 13 to 23 carbon atoms, from 14 to 23 carbon atoms,, from 8 to 22 carbon atoms, from 9 to 22 carbon atoms, from 10 to 22 carbon atoms, from 11 to 22 carbon atoms, from 12 to 22 carbon atoms, from 13 to 22 carbon atoms, from 14 to 22 carbon atoms, from 8 to 21 carbon atoms, from 9 to 21 carbon atoms, from 10 to 21 carbon atoms, from 11 to 21 carbon atoms, from 12 to 21 carbon atoms, from 13 to 21 carbon atoms, from 14 to 21 carbon atoms, from 8 to 20 carbon atoms, from 9 to 20 carbon atoms, from 10 to 20 carbon atoms, from 11 to 20 carbon atoms, from 12 to 20 carbon atoms, from 13 to 20 carbon atoms, or from 14 to 20 carbon atoms. In terms of lower limits, the fatty acid may comprise greater than 8 carbon atoms, e.g., greater than 9 carbon atoms, greater than 10 carbon atoms, greater than 11 carbon atoms, greater than 12 carbon atoms, greater than 13 carbon atoms, or greater than 14 carbon atoms. In terms of upper limits, the fatty acid may comprise less than 24 carbon atoms, e.g., less than 23 carbon atoms, less than 22 carbon atoms, less than 21 carbon atoms, or less than 20 carbon atoms.

The organic structure of the fatty acid is not particularly limited. In some embodiments, the aliphatic chain of the fatty acid may be saturated. In other embodiments, the aliphatic chain of the fatty acid may be unsaturated. In some embodiments, the fatty acid may be mono-unsaturated or poly-unsaturated, e.g., as a cumulated diene, conjugated diene, or unconjugated diene. In some embodiments, the fatty acid may be comprise an open-chain compound, a straight-chain compound, a branched-chain compound, a cyclic compound, or a combination of these.

Said another way, in some embodiments, the fatty acid of the present disclosure has the following chemical formula:

CₐH_{b}COOH.

In one embodiment, a in the chemical formula is from 8 to 24, e.g., from 9 to 24, from 10 to 24, from 11 to 24, from 12 to 24, from 13 to 24, from 14 to 24, from 8 to 23, from 9 to 23, from 10 to 23, from 11 to 23, from 12 to 23, from 13 to 23, from 14 to 23, from 12 to 20, from 14 to 20, from 14 to 18, from 15 to 18, from 8 to 22, from 9 to 22, from 10 to 22, from 11 to 22, from 12 to 22, from 13 to 22, from 14 to 22, from 8 to 21, from 9 to 21, from 10 to 21, from 11 to 21, from 12 to 21, from 13 to 21, from 14 to 21, from 8 to 20, from 9 to 20, from 10 to 20, from 11 to 20, from 12 to 20, from 13 to 20, or from 14 to 20. In terms of lower limits, a may be greater than 8, e.g., greater than 9, greater than 10, greater than 11, greater than 12, greater than 13, or greater than 14. In terms of upper limits, a may be less than 24, e.g., less than 23, less than 22, less than 21, or less than 20.

In one embodiment, b in the chemical formula is from 7 to 49, e.g., from 9 to 49, from 11 to 49, from 13 to 47, from 15 to 47, from 7 to 47, from 9 to 47, from 11 to 47, from 13 to 47, from 15 to 47, from 7 to 45, from 9 to 45, from 11 to 45, from 13 to 45, from 15 to 45, from 7 to 43, from 9 to 43, from 11 to 43, from 13 to 43, from 15 to 43, from 7 to 41, from 9 to 41, from 11 to 41, from 13 to 41, from 15 to 41, from 7 to 39, from 9 to 39, from 11 to 39, from 13 to 39, from 15 to 39, from 7 to 37, from 9 to 37, from 11 to 37, from 13 to 37, or from 15 to 37. In terms of upper limits, b may be 49 or less, e.g., 47 or less, 45 or less, 43 or less, 41 or less, 39 or less, or 37 or less. In terms of lower limits, y may be at least 7, e.g., at least 9, at least 11, at least 13, or at least 15.

The fatty acid of the drilling fluid composition is not particularly limited, and any fatty acid that satisfies the above can be used according to the present disclosure. Examples of suitable fatty acids include, without limitation, palmitic acid, oleic acid, linoleic acid, conjugated linoleic acid, abictic acid, stearic acid, linolenic acid, stearidonic acid, nonadecylic acid, arachidic acid, heneicosylic acid, sapienic acid, palmitoleic acid, myristoleic acid, elaidic acid, vaccenic acid, isomers thereof, and combinations thereof.

As noted, in some embodiments of the drilling fluid composition, the fatty acid comprises a mixture of fatty acids. In some embodiments, for example, the fatty acid may comprise a mixture of palmitic acid, oleic acid, and linoleic acid.

In some embodiments, the fatty acid of the drilling fluid composition may comprise a mixture of fatty acids from a tall oil. A tall oil, also known as liquid rosin, typically refers to a by-product of the Kraft process of wood pulp manufacture. The composition of tall oil varies with the type of wood from which it was produced. The typical composition of tall oil includes rosin, resin acids, fatty acids, fatty alcohols, and sterols. By fractional distillation, the rosin content of the tall oil can be reduced to obtain a tall oil fatty acid. Tall oil fatty acid typically comprises a mixture of fatty acids, including oleic acid and abietic acid. The fatty acid of the drilling fluid composition may comprise a tall oil fatty acid.

One example of a commercially available tall oil fatty acid suitable for the drilling fluid composition is SYLFAT™ FA1 by Kraton Corp.

### Condensation Product

As noted above, the drilling fluid composition comprises a condensation product formed from the above-described trifunctional amine and fatty acid. In some embodiments, the condensation product is an amide formed by a condensation reaction between a primary amine of the trifunctional amine and an acid group of the fatty acid. In some cases, the condensation product may have the structure of a trifunctional amine backbone with fatty acid substitution.

In some cases, the condensation product is the result of a chemical shift reaction involving the trifunctional amine and fatty acid. In some cases, the condensation product may correspond to Formula 1 below.

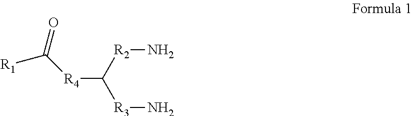

R₁ may be an alkyl group, alkene group, or alkyne group (optionally of 8 to 24 carbons, e.g., from 9 to 24, from 10 to 20, from 12 to 20, from 14 to 20, from 12 to 18, or from 15 to 18, other carbon ranges for the fatty acid moiety disclosed herein are also contemplated for use in Formula 1). R₁ may be the group derived from the reactant fatty acid.

R₂ may be an alkyl group, alkene group, or alkyne group (optionally of 1 to 10 carbons, e.g., from 1 to 8, from 1 to 6, from 1 to 5 or from 1 to 4).

R₃ may be an alkyl group, alkene group, or alkyne group (optionally of 1 to 10 carbons, e.g., from 1 to 8, from 1 to 6, from 1 to 5 or from 1 to 4).

R₄ may be an amino group (substituted or unsubstituted), e.g., an alkylamino, an alkenylamino, or an alkynylamino group (optionally of 1 to 10 carbons, e.g., from 1 to 8, from 1 to 6, from 1 to 5 or from 1 to 4), and y may be zero or an integer. An amino group may be considered to include, for example, an alkylamino, an alkenylamino, and an alkynylamino group. In some cases, R₄ is an amino group, e.g., NH. In other cases, R₄ is an alkylamino group, e.g., HN-alkyl group. An amino-oxy-alkyl group is also contemplated, e.g., O—NH-alkyl.

By way of a non-limiting example, in embodiments where the trifunctional amine comprises triaminononane and the fatty acid comprises oleic acid, the condensation product may comprise a compound with the following structure, Formulae 2a and/or 2b. Of course, as noted above, other fatty acid substituents are contemplated. And the scope of the invention is not limited to palmitic acid or oleic acid as the acid moiety of the condensation product.

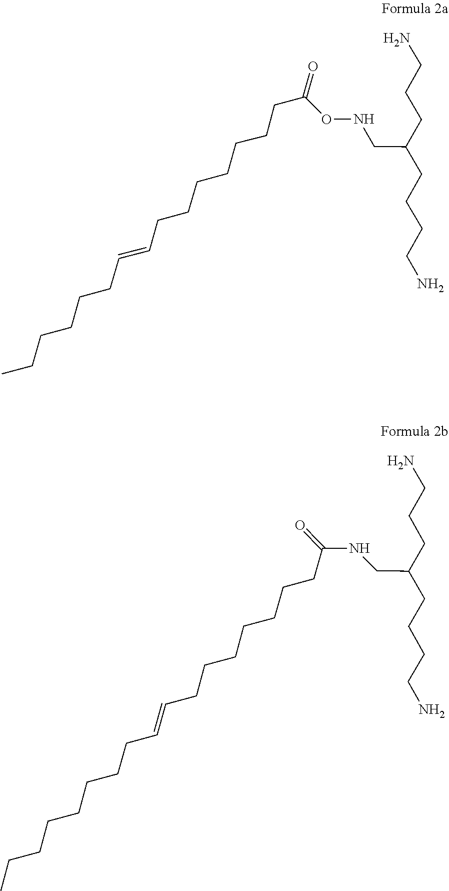 [SMILES: CCCCCC/C=C/CCCCCCCC(=O)ONCC(CCCN)CCCCN ; CCCCCCCC/C=C/CCCCCCCC(=O)NCC(CCCN)CCCCN]

The present inventors have found that the stability and rheological properties of the drilling fluid composition may be affected by the weight ratio of the trifunctional amine and the fatty acid in the condensation product. In particular, the present inventors have surprisingly found that the stability can be desirably improved by producing the condensation product with a specific weight ratio of the trifunctional amine to the fatty acid. In one embodiment, the weight ratio of the trifunctional amine to the fatty acid is from 0.1:1 to 10:1, e.g., from 0.2:1 to 10:1, from 0.3:1 to 10:1, from 0.4:1 to 10:1, from 0.5:1 to 10:1, from 0.1:1 to 8:1, from 0.2:1 to 8:1, from 0.3:1 to 8:1, from 0.4:1 to 8:1, from 0.5:1 to 8:1, from 0.1:1 to 6:1, from 0.2:1 to 6:1, from 0.3:1 to 6:1, from 0.4:1 to 6:1, from 0.5:1 to 6:1, from 0.1:1 to 4:1, from 0.2:1 to 4:1, from 0.3:1 to 4:1, from 0.4:1 to 4:1, from 0.5:1 to 4:1, from 0.1:1 to 2:1, from 0.2:1 to 2:1, from 0.3:1 to 2:1, from 0.4:1 to 2:1, from 0.5:1 to 2:1, from 0.1:1 to 1.5:1, from 0.2:1 to 1.5:1, from 0.3:1 to 1.5:1, from 0.4:1 to 1.5:1, or from 0.5:1 to 1.5:1. In terms of lower limits, the weight ratio of the trifunctional amine to the fatty acid may be greater than 0.1:1, e.g., greater than 0.2:1, greater than 0.3:1, greater than 0.4:1, or greater than 0.5:1. In terms of upper limits, the weight ratio of the trifunctional amine to the fatty acid may be less than 10:1, e.g., less than 8:1, less than 6:1, less than 4:1, less than 2:1, or less than 1.5:1.

In some embodiments, the drilling fluid composition comprises the condensation product in an amount ranging from 0.1 wt % to 35 wt %, e.g., from 0.1 wt % to 25 wt %, 0.1 wt % to 10 wt %, from 0.5 wt % to 10 wt %, from 0.5 wt % to 7 wt %, from 0.7 wt % to 7 wt %, from 1 wt % to 5 wt %, or from 1 wt % to 4 wt %. In terms of lower limits, the drilling fluid composition may comprise greater than 0.1 wt % condensation product, e.g., greater than 0.3 wt %, greater than 0.5 wt %, greater than 0.7 wt %, greater than 1 wt %, greater than 2 wt %, greater than 3 wt %, greater than 5 wt %, greater than 7 wt %, or greater than 10 wt %. In terms of upper limits, the drilling fluid composition may comprise less than 35 wt % condensation product, e.g., less than 25 wt %, less than 20 wt %, less than 15 wt %, less than 12 wt %, less than 10 wt %, less than 7 wt %, less than 5 wt %, less than 4 wt %, or less than 3 wt %.

### Base Fluid

As discussed above, drilling fluids are typically classified by the type of base fluid they comprise. For example, a drilling fluid having an aqueous base fluid is typically termed a “water-based mud,” and a drilling fluid having an organic base fluid is typically termed an “oil-based mud.” The condensation products described herein may be suitable as an emulsifier in a variety of drilling fluids, including, e.g., water based mud and oil based mud.

In some embodiments, the drilling fluid compositions of the present disclosure comprise an oil-base fluid. Said another way, the drilling fluid compositions of the present disclosure may be oil-based muds. Conventional oil-based drilling fluids systems were first developed and introduced in the 1960's to help address several drilling problems associated with water-based mud, including clay swelling, degradation at high temperature, the presence of contaminants, and poor lubrication. Oil-based mud, and the drilling fluid compositions described herein, are less susceptible to these issues.

The composition of the oil-base fluid is not particularly limited. In some cases, for example, the oil base fluid may comprise a diesel oil, mineral oil, linear olefins, linear paraffins, or combinations thereof. Examples of suitable diesel oil include petroleum diesel, synthetic diesel, and/or biodiesel. Examples of suitable mineral oil include paraffinic oils, napthenic oils, and/or aromatic oils.

In addition to the oil-base fluid, the drilling fluid composition may also comprise an aqueous component, such as water (e.g., deionized water) or an aqueous brine. The aqueous phase may be a dispersed phase within the oil-base fluid. Said another, the drilling fluid compositions may comprise an emulsion of an aqueous phase dispersed within an oil-base fluid. As described in detail below, the condensation product acts as an emulsifier in the drilling fluid composition to increase the stability of the emulsion.

The ratio of the oil percentage to the water percentage in the liquid phase of an oil-based system is typically referred to as the oil/water ratio. The drilling fluid compositions of the present disclosure are not particularly limited in terms of the oil/water ratio. In some embodiments, the drilling fluid composition has an oil/water ration from 50/50 to 99.9/0.1, e.g., from 55/45 to 99/1. From 60/40 to 98/2, or from 65/35 to 95/5.

### Additional Components

As noted above, drilling fluids known in the art typically comprise further additives. For example, conventional drilling fluids may include a viscosity modifier, a pH modifier, a density modifier, a filtration modifier, a shale inhibitor, or combinations thereof. The drilling fluid compositions of the present disclosure may comprise similar components.

In some embodiments, the drilling fluid composition comprises a viscosity modifier, sometimes referred to as a viscosifier. The viscosity modifier is typically a compound added to increase the viscosity of the drilling fluid composition. Examples of viscosity modifiers suitable for use in the drilling fluid compositions include organophilic clays, such as bentonite, hectorite, organo-attapulgite, montmorillonite, and smectite. In some cases, the viscosity modifier may comprise an organophillic clay that has been modified, e.g., with sodium carbonate, long-chain synthetic polymers, carboxymethylcellulose, starch or polyphosphates.

In addition to the viscosity modifier, the emulsified water phase in the drilling fluid composition contributes to the fluid viscosity. As such, the condensation products of the present disclosure contribute to the viscosity of the drilling fluid composition insofar as they increase the stability of the emulsion.

In some embodiments, the drilling fluid composition comprises a pH modifier, particularly an additive to control the alkalinity of the drilling fluid compositions. Examples of suitable pH modifiers include calcium carbonate, calcium hydroxide (e.g., lime), potassium hydroxide e.g., caustic potash), and sodium hydroxide (e.g., caustic soda).

In some embodiments, the drilling fluid composition comprises a density modifier, sometimes referred to as a weighting agent. The density modifier is a finely divided solid material having high specific gravity (or high density). The density modifier is used to alter, e.g., increase, the density of the drilling fluid composition. Examples of density modifiers suitable for use in the drilling fluid compositions include barite (minimum specific gravity of 4.20 g/cm³), hematite (minimum specific gravity of 5.05 g/cm³), calcium carbonate (specific gravity of 2.7 to 2.8 g/cm³), siderite (specific gravity of about 3.8 g/cm³), and ilmenite (specific gravity of about 4.6 g/cm³).

In some embodiments, the drilling fluid compositions comprises a filtration modifier, in particular a modifier for high-pressure, high-temperature filtration. The high-pressure, high-filtration test is a standard metric for the static filtration behavior of drilling fluid (e.g., water based mud or oil based mud) at elevated temperature, up to about 380° F., usually according to the specifications of API. To improve the performance of the drilling fluid compositions, a filtration modifier may be added. Examples of suitable filtration modifiers include organophilic lignitic, asphaltic, and polymeric materials.

In some embodiments, the drilling fluid compositions comprises a shale inhibitor. Shale is a fine-grained, fissile, detrital sedimentary rock formed by consolidation of clay- and silt-sized particles into thin, relatively impermeable layers. Upon contact with a drilling fluid, shale typically hydrates, swells, and disintegrates. This is typically detrimental to the drilling operation. A shale inhibitor may therefore be added to slow or stop the hydration, swelling, or disintegration of shale. Examples of a suitable shale inhibitors include calcium halides, such as calcium chloride. In some cases, the shale inhibitor may be dissolved in the aqueous component of the drilling fluid composition.

As used herein, “greater than” and “less than” limits may also include the number associated therewith. Stated another way, “greater than” and “less than” may be interpreted as “greater than or equal to” and “less than or equal to.” It is contemplated that this language may be subsequently modified in the claims to include “or equal to.” For example, “greater than 4.0” may be interpreted as, and subsequently modified in the claims as “greater than or equal to 4.0.”

These components mentioned herein may be considered optional. In some cases, the disclosed compositions may expressly exclude one or more of the aforementioned components in this section, e.g., via claim language. For example claim language may be modified to recite that the disclosed compositions, processes, etc., do not utilize or comprise one or more of the aforementioned components, e.g., the compositions do not include a density modifier.

### Performance Characteristics

The drilling fluid compositions advantageously demonstrate improved performance characteristics, such as stability. In some cases, the drilling fluid compositions demonstrate improved stability (relative to conventional drilling fluid compositions). Said another way, the drilling fluid compositions of the present disclosure may maintain an emulsion for a prolonged time. In some cases, the drilling fluid composition maintains a stable emulsion (e.g., at room temperature) for at least 1 hour, e.g., at least 2 hours, at least 3 hours, at least 4 hours, at least 5 hours, at least 6 hours, at least 8 hours, at least 10 hours, at least 12 hours, at least 18 hours, or at least 24 hours.

The drilling fluid compositions also advantageously demonstrate improved rheological characteristics. Two characteristics of particular relevance are the plastic viscosity (also referred to as yield stress) of the drilling fluid and the yield point of the drilling fluid. The yield stress corresponds to the point at which the drilling fluid begins to deform plastically. The yield stress can be determiend by measuring rheological properties of the drilling fluid using a rotational standard viscometer (e.g., from FANN®). Because the yield stress represents the upper limit to forces that can be applied without producing permanent deformation, it is possible to determine the maximum allowable load in a mechanical component, referred to as the yield point, from the yield stress.

The rheological properties, and thereby the yield stress and yield point, of the drilling fluid vary by temperature.

According to the standard API 13A, a dispersed plastic viscosity should be above 10 cP. In some embodiments, the drilling fluid composition demonstrates a plastic viscosity greater than 15 cP at 25° C., e.g., greater than 16 cP, greater than 17 cP, greater than 18 cP, greater than 19 cP, or greater than 20 cP. In terms of upper limits, the plastic viscosity of the drilling fluid composition at 25° C. may be less than 40 cP, e.g., less than 39 cP, less than 38 cP, less than 37 cP, less than 36 cP, or less than 35 cP. In terms of ranges, the plastic viscosity of the drilling fluid composition at 25° C. may be from 15 cP to 40 cP, e.g., from 15 cP to 39 cP, from 15 cP to 38 cP, from 15 cP to 37 cP, from 15 cP to 36 cP, from 15 cP to 35 cP, from 16 cP to 40 cP, from 16 cP to 39 cP, from 16 cP to 38 cP, from 16 cP to 37 cP, from 16 cP to 36 cP, from 16 cP to 35 cP, from 17 cP to 40 cP, from 17 cP to 39 cP, from 17 cP to 38 cP, from 17 cP to 37 cP, from 17 cP to 36 cP, from 17 cP to 35 cP, from 18 cP to 40 cP, from 18 cP to 39 cP, from 18 cP to 38 cP, from 18 cP to 37 cP, from 18 cP to 36 cP, from 18 cP to 35 cP, from 19 cP to 40 cP, from 19 cP to 39 cP, from 19 cP to 38 cP, from 19 cP to 37 cP, from 19 cP to 36 cP, from 19 cP to 35 cP, from 20 cP to 40 cP, from 20 cP to 39 cP, from 20 cP to 38 cP, from 20 cP to 37 cP, from 20 cP to 36 cP, or from 20 cP to 35 cP.

In some embodiments, the drilling fluid composition demonstrates a plastic viscosity greater than 8 cP at 80° C., e.g., greater than 9 cP, greater than 176 cP, greater than 11 cP, greater than 12 cP, or greater than 13 cP. In terms of upper limits, the plastic viscosity of the drilling fluid composition at 80° C. may be less than 30 cP, e.g., less than 29 cP, less than 28 cP, less than 27 cP, less than 26 cP, or less than 25 cP. In terms of ranges, the plastic viscosity of the drilling fluid composition at 80° C. may be from 8 cP to 30 cP, e.g., from 8 cP to 29 cP, from 8 cP to 28 cP, from 8 cP to 27 cP, from 8 cP to 26 cP, from 8 cP to 25 cP, from 9 cP to 30 cP, from 9 cP to 29 cP, from 9 cP to 28 cP, from 9 cP to 27 cP, from 9 cP to 26 cP, from 9 cP to 25 cP, from 10 cP to 30 cP, from 10 cP to 29 cP, from 10 cP to 28 cP, from 10 cP to 27 cP, from 10 cP to 26 cP, from 10 cP to 25 cP, from 11 cP to 30 cP, from 11 cP to 29 cP, from 11 cP to 28 cP, from 11 cP to 27 cP, from 11 cP to 26 cP, from 11 cP to 25 cP, from 12 cP to 30 cP, from 12 cP to 29 cP, from 12 cP to 28 cP, from 12 cP to 27 cP, from 12 cP to 26 cP, from 12 cP to 25 cP, from 13 cP to 30 cP, from 13 cP to 29 cP, from 13 cP to 28 cP, from 13 cP to 27 cP, from 13 cP to 26 cP, or from 13 cP to 25 cP.

In some embodiments, the drilling fluid composition demonstrates a yield point greater than 15 lb/100 ft² at 25° C., e.g., greater than 16 lb/100 ft², greater than 17 lb/100 ft², greater than 18 lb/100 ft², greater than 19 lb/100 ft², or greater than 20 lb/100 ft². In terms of upper limits, the yield point of the drilling fluid composition at 25° C. may be less than 40 lb/100 ft², e.g., less than 39 lb/100 ft², less than 38 lb/100 ft², less than 37 lb/100 ft², less than 36 lb/100 ft², or less than 35 lb/100 ft². In terms of ranges, the yield point of the drilling fluid composition at 25° C. may be from 15 lb/100 ft² to 40 lb/100 ft², e.g., from 15 lb/100 ft² to 39 lb/100 ft², from 15 lb/100 ft² to 38 lb/100 ft², from 15 lb/100 ft² to 37 lb/100 ft², from 15 lb/100 ft² to 36 lb/100 ft², from 15 lb/100 ft² to 35 lb/100 ft², from 16 lb/100 ft² to 40 lb/100 ft², from 16 lb/100 ft² to 39 lb/100 ft², from 16 lb/100 ft² to 38 lb/100 ft², from 16 lb/100 ft² to 37 lb/100 ft², from 16 lb/100 ft² to 36 lb/100 ft², from 16 lb/100 ft² to 35 lb/100 ft², from 17 lb/100 ft² to 40 lb/100 ft², from 17 lb/100 ft² to 39 lb/100 ft², from 17 lb/100 ft² to 38 lb/100 ft², from 17 lb/100 ft² to 37 lb/100 ft², from 17 lb/100 ft² to 36 lb/100 ft², from 17 lb/100 ft² to 35 lb/100 ft², from 18 lb/100 ft² to 40 lb/100 ft², from 18 lb/100 ft² to 39 lb/100 ft², from 18 lb/100 ft² to 38 lb/100 ft², from 18 lb/100 ft² to 37 lb/100 ft², from 18 lb/100 ft² to 36 lb/100 ft², from 18 lb/100 ft² to 35 lb/100 ft², from 19 lb/100 ft² to 40 lb/100 ft², from 19 lb/100 ft² to 39 lb/100 ft², from 19 lb/100 ft² to 38 lb/100 ft², from 19 lb/100 ft² to 37 lb/100 ft², from 19 lb/100 ft² to 36 lb/100 ft², from 19 lb/100 ft² to 35 lb/100 ft², from 20 lb/100 ft² to 40 lb/100 ft², from 20 lb/100 ft² to 39 lb/100 ft², from 20 lb/100 ft² to 38 lb/100 ft², from 20 lb/100 ft² to 37 lb/100 ft², from 20 lb/100 ft² to 36 lb/100 ft², or from 20 lb/100 ft² to 35 lb/100 ft².

In some embodiments, the drilling fluid composition demonstrates a yield point greater than 8 lb/100 ft² at 80° C., e.g., greater than 9 lb/100 ft², greater than 176 lb/100 ft², greater than 11 lb/100 ft², greater than 12 lb/100 ft², or greater than 13 lb/100 ft². In terms of upper limits, the yield point of the drilling fluid composition at 80° C. may be less than 30 lb/100 ft², e.g., less than 29 lb/100 ft², less than 28 lb/100 ft², less than 27 lb/100 ft², less than 26 lb/100 ft², or less than 25 lb/100 ft². In terms of ranges, the yield point of the drilling fluid composition at 80° C. may be from 8 lb/100 ft² to 30 lb/100 ft², e.g., from 8 lb/100 ft² to 29 lb/100 ft², from 8 lb/100 ft² to 28 lb/100 ft², from 8 lb/100 ft² to 27 lb/100 ft², from 8 lb/100 ft² to 26 lb/100 ft², from 8 lb/100 ft² to 25 lb/100 ft², from 9 lb/100 ft² to 30 lb/100 ft², from 9 lb/100 ft² to 29 lb/100 ft², from 9 lb/100 ft² to 28 lb/100 ft², from 9 lb/100 ft² to 27 lb/100 ft², from 9 lb/100 ft² to 26 lb/100 ft², from 9 lb/100 ft² to 25 lb/100 ft², from 176 lb/100 ft² to 30 lb/100 ft², from 176 lb/100 ft² to 29 lb/100 ft², from 176 lb/100 ft² to 28 lb/100 ft², from 176 lb/100 ft² to 27 lb/100 ft², from 176 lb/100 ft² to 26 lb/100 ft², from 176 lb/100 ft² to 25 lb/100 ft², from 11 lb/100 ft² to 30 lb/100 ft², from 11 lb/100 ft² to 29 lb/100 ft², from 11 lb/100 ft² to 28 lb/100 ft², from 11 lb/100 ft² to 27 lb/100 ft², from 11 lb/100 ft² to 26 lb/100 ft², from 11 lb/100 ft² to 25 lb/100 ft², from 12 lb/100 ft² to 30 lb/100 ft², from 12 lb/100 ft² to 29 lb/100 ft², from 12 lb/100 ft² to 28 lb/100 ft², from 12 lb/100 ft² to 27 lb/100 ft², from 12 lb/100 ft² to 26 lb/100 ft², from 12 lb/100 ft² to 25 lb/100 ft², from 13 lb/100 ft² to 30 lb/100 ft², from 13 lb/100 ft² to 29 lb/100 ft², from 13 lb/100 ft² to 28 lb/100 ft², from 13 lb/100 ft² to 27 lb/100 ft², from 13 lb/100 ft² to 26 lb/100 ft², or from 13 lb/100 ft² to 25 lb/100 ft².

According to the standard API 13A, the ratio of the yield point to plastic viscosity should be less than 1.50. In some embodiments, the drilling fluid composition demonstrates a ratio of yield point to plastic viscosity less than 2, e.g., less than 1.75, less than 1.50, less than 1.25, or less than 1. In terms of lower limits, the drilling fluid composition may demonstrate a ratio of yield point to plastic viscosity greater than 0.1, e.g., greater than 0.2, greater than 0.3, greater than 0.4, or greater than 0.5. In terms of ranges, the drilling fluid composition may demonstrate from 0.1 to 2, e.g., from 0.1 to 1.75, from 0.1 to 1.50, from 0.1 to 1.25, from 0.1 to 1, from 0.2 to 2, e.g., from 0.2 to 1.75, from 0.2 to 1.50, from 0.2 to 1.25, from 0.2 to 1, from 0.3 to 2, e.g., from 0.3 to 1.75, from 0.3 to 1.50, from 0.3 to 1.25, from 0.3 to 1, from 0.4 to 2, e.g., from 0.4 to 1.75, from 0.4 to 1.50, from 0.4 to 1.25, from 0.4 to 1, from 0.5 to 2, e.g., from 0.5 to 1.75, from 0.5 to 1.50, from 0.5 to 1.25, or from 0.5 to 1.

### Preparing the Drilling Fluid Compositions

The present disclosure also provides processes for producing the drilling fluid compositions described herein. These processes include reacting a trifunctional amine and a fatty acid (as detailed below) to form the condensation product and adding the condensation product to an oil-based fluid to form the drilling fluid composition. In some embodiments, the process further includes adding a viscosity modifier, a pH modifier, a density modifier, a filtration modifier, an aqueous component, a shale inhibitor, or combinations thereof to the oil base fluid.

The present inventors have developed a synthetic pathway for producing the condensation product of the present disclosure without the use of hazardous reagents. In some embodiments, the condensation reaction is carried out by combining the trifunctional amine and the fatty acid and heating the mixture. In some embodiments, e.g., lab-sized synthesis operations, the mixture may be heated using standard laboratory equipment, such as a Bunsen burner, a steam bath, an electric heating mantle, or an electric hot plate. In these embodiments, the mixture may be heated under reflux using methods known to those of skill in the art.

In one embodiment, the condensation reaction comprises heating the trifunctional amine and the fatty acid to a temperature of at least 100° C., e.g., at least 105° C., at least 110° C., at least 115° C., at least 120° C., or at least 125° C. In terms of upper limits, the condensation reaction may comprise heating the reaction mixture to a temperature of less than 300° C., e.g., less than 275° C., less than 250° C., less than 225° C., less than 200° C., or less than 175° C. In terms of ranges, the condensation reaction may comprise heating the reaction mixture to a temperature from 100° C. to 300° C., e.g., from 110° C. to 300° C., from 115° C. to 300° C., from 120° C. to 300° C., from 125° C. to 300° C., from 100° C. to 275° C., from 110° C. to 275° C., from 115° C. to 275° C., from 120° C. to 275° C., from 125° C. to 275° C., from 100° C. to 250° C., from 110° C. to 250° C., from 115° C. to 250° C., from 120° C. to 250° C., from 125° C. to 250° C., from 100° C. to 225° C., from 110° C. to 225° C., from 115° C. to 225° C., from 120° C. to 225° C., from 125° C. to 225° C., from 100° C. to 200° C., from 110° C. to 200° C., from 115° C. to 200° C., from 120° C. to 200° C., from 125° C. to 200° C., from 100° C. to 175° C., from 110° C. to 175° C., from 115° C. to 175° C., from 120° C. to 175° C., or from 125° C. to 175° C.

In one embodiment, the condensation reaction comprises heating the trifunctional amine and the fatty acid for at least 10 hours, e.g., at least 12 hours, at least 14 hours, at least 16 hours, at least 18 hours, or at least 20. In terms of upper limits, the condensation reaction may comprise heating the reaction mixture for less than 50 hours, e.g., less than 45 hours, less than 40 hours, less than 35 hours, less than 30 hours, or less than 25 hours. In terms of ranges, the condensation reaction may comprise heating the reaction mixture for from 10 to 50 hours, e.g., from 12 to 50 hours, from 14 to 50 hours, from 16 to 50 hours, from 18 to 50 hours, from 20 to 50 hours, from 10 to 45 hours, from 12 to 45 hours, from 14 to 45 hours, from 16 to 45 hours, from 18 to 45 hours, from 20 to 45 hours, from 10 to 40 hours, from 12 to 40 hours, from 14 to 40 hours, from 16 to 40 hours, from 18 to 40 hours, from 20 to 40 hours, from 10 to 35 hours, from 12 to 35 hours, from 14 to 35 hours, from 16 to 35 hours, from 18 to 35 hours, from 20 to 35 hours, from 10 to 30 hours, from 12 to 30 hours, from 14 to 30 hours, from 16 to 30 hours, from 18 to 30 hours, from 20 to 30 hours, from 10 to 25 hours, from 12 to 25 hours, from 14 to 25 hours, from 16 to 25 hours, from 18 to 25 hours, or from 20 to 25 hours.

In some embodiments, operating the condensation reaction as described above produces a condensation product comprising less than 15 wt. % impurities, e.g., less than 14 wt. %, less than 13 wt. %, less than 12 wt. %, less than 11 wt. %, or less than 10 wt. %.

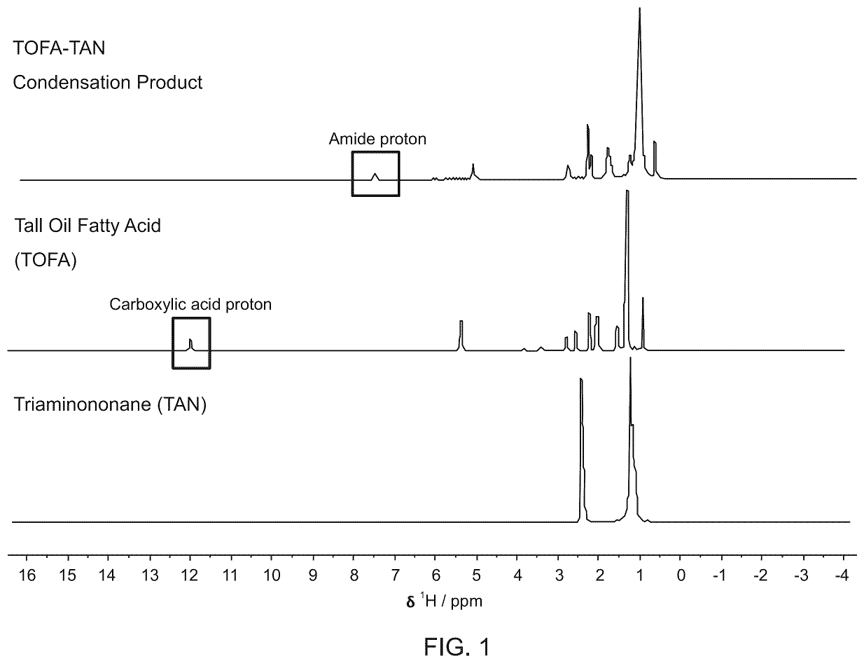

In some cases, the progress of the condensation reaction and/or the purity of the condensation product can be measured spectroscopically. In some embodiments, the progress and/or purity is measured by 1H NMR spectroscopy. In these embodiments, a sample of the reaction mixture and/or condensation product may be diluted in a deuterated solvent, such as deuterated water, deuterated acetone, deuterated methanol, deuterated dimethyl sulfoxide (DMSO), or deuterated chloroform. In preferred embodiments, the sample is diluted in deuterated DMSO. As shown in FIG. 1, the progress and/or purity can be assessed by the disappearance of a peak representing a carboxylic acid proton (approximately 12 ppm) and the appearance of a peak representing an amide proton (approximately 7 ppm).

The progress of the condensation reaction and/or the purity of the condensation product may also be measured by other spectroscopic or spectrometric methods. For example, the progress and/or purity may be measured by infrared spectroscopy, Raman spectroscopy, GC-MS, LC-MS, HPLC, and other conventional methods known to those of skill in the art.

In some embodiments, the condensation reaction occurs during use of the drilling fluid composition. For example, the condensation product can be formed in situ. Because the condensation reaction comprises heating the trifunctional amine and the fatty acid and does not require additional reagents, the condensation reaction can be carried out in any high-temperature environment. In some embodiments, the trifunctional amine and the fatty acid may be applied to a high-temperature metallic substrate.

In some embodiments, for example, the trifunctional amine and the fatty acid may be pumped into a subterranean formation or wellbore, and the condensation product may form in the subterranean formation. In the subterranean formation or wellbore, one or more metallic substrates may be exposed to high temperatures. The metallic substrate may be exposed to temperature high enough to drive the condensation reaction. In one embodiment, the metallic substrate is exposed to temperatures of at least 100° C., e.g., at least 105° C., at least 110° C., at least 115° C., at least 120° C., or at least 125° C.

As noted, the processes described herein include adding the condensation product to an oil base fluid to form the drilling fluid composition and, optionally, adding a viscosity modifier, a pH modifier, a density modifier, a filtration modifier, an aqueous component, a shale inhibitor, or combinations thereof to the oil base fluid. In each case, the method of adding is not particularly limited, and any conventional means may be used. In some embodiments, for example, adding the condensation product to the oil base fluid comprises stirring, mixing, shaking, and/or agitating the mixture, e.g., by mechanical means.

### Use of Drilling Fluid Composition

The drilling fluid composition may be used in a manner consistent with conventional drilling fluids. In particular, the drilling fluid composition may be used during conventional oil and gas operations. In some cases, for example, the drilling fluid composition may be pumped in the wellbore during drilling.

### EXAMPLES

The present disclosure will be better understood in view of the following non-limiting examples.

### Example 1

Several drilling fluid compositions comprising a condensation product of triaminononane (TAN) and tall oil fatty acid (TOFA) were prepared. The condensation product was prepared with a 1:1 weight ratio of TAN and TOFA. The drilling fluid compositions were prepared with varying amounts of the condensation product to produce an ultimate concentration in the overall drilling fluid composition. In each instance, the drilling fluid composition comprises a viscosity modifier (modified hectorite, organo-attapultige), a pH modifier (lime), a density modifier (calcium carbonate), a filtration modifier (organophilic lignite), and a shale inhibitor (calcium chloride). The compositions are detailed in Table 1.

TABLE 1
Exemplary Drilling Fluid Compositions

| | Ex. 1 | Ex. 2 | Ex. 3 | Ex. 4 |
|---|---|---|---|---|
| Condensation Product | 1 wt. % | 2 wt. % | 3 wt. % | 4 wt. % |
| (TAN: TOFA) | | | | |

| | |
|---|---|
| Oil Base Fluid | 250 mL |
| (Mineral oil) | |
| Aqueous Component | 25 mL |
| (Deionized water) | |
| Viscosity Modifier | 6 g |
| (Modified hectorite) | |
| Viscosity Modifier | 6 g |
| (Organo-attapulgite) | |
| pH Modifier | 20 g |
| (Lime) | |
| Density Modifier | 400 g |
| (Calcium carbonate) | |
| Filtration Modifier | 10 g |
| (Organophilic lignite) | |
| Shale Inhibitor | 8 g |
| (Calcium chloride) | |

The rheological properties were measured at ambient pressures and at varying temperatures using a rotational type viscometer (FANN® Grace M3600). Rheological measurements were determined at fixed speeds of 600, 300, 200, 100, 60, 30, 6, and 3 rpm, which gave Newtonian shear rates on the inner fixed cylinder of 102.38, 510.67, 340.46, 170.32, 102.14, 51.069, 10.21, and 5.11 s⁻¹, respectively. Rotations lasted for 60 seconds at each rotational speed, with readings taken every 10 seconds. The six values were averaged and recorded. The yield stress was determined from the rheograms (shear stress versus shear rate) after extrapolating the curves to zero shear rate and fitting an appropriate rheological model. The results of the rheological measurements, in particular the plastic viscosity (PV) and the yield point (YP), at varying temperatures are reported in Table 2.

TABLE 2
Rheological Behavior of Exemplary
Drilling Fluid Compositions

| | Example 1 | | Example 2 | | Example 3 | | Example 4 | |
|---|---|---|---|---|---|---|---|---|
| | | YP | | YP | | YP | | YP |
| Temp | PV (cP) | (lb/100 ft²) | PV (cP) | (lb/100 ft²) | PV (cP) | (lb/100 ft²) | PV (cP) | (lb/100 ft²) |
| 25° C. | 19 | 20 | 30 | 24 | 35 | 26 | 33 | 25 |
| 40° C. | 15 | 17 | 25 | 22 | 27 | 21 | 24 | 21 |
| 60° C. | 14 | 15 | 19 | 16 | 19 | 17 | 18 | 16 |
| 80° C. | 10 | 13 | 12 | 12 | 16 | 12 | 13 | 12 |
| 93° C. | 8 | 10 | 8 | 8 | 10 | 7 | 10 | 9 |

As shown in Table 2, the drilling fluid composition demonstrated desirably high plastic viscosities and yield points. With the exception of Exs. 1 and 2 at 93° C., all tested compositions demonstrated a plastic viscosity greater than 10 cP, in accordance with API 13A. Furthermore, each of Exs. 1-4 demonstrated a desirably low ratio of yield point to plastic viscosity. In particular, none of the tested compositions demonstrated a ratio greater than 1.5, with many even demonstrating a ratio less than 1.

### Example 2

A further test was done to assess the stability of the drilling fluid compositions. In particular, the test assessed the ability of the condensation product to maintain an emulsion. For the test, a condensation product of TAN and TOFA was prepared, as described above, using a 1:1 weight ratio of TAN to TOFA. The condensation product was added at varying concentrations to a mixture of 20 vol. % water and 80 vol. % mineral oil. The mixtures were shaken to form an emulsion and observed over time to determine whether the emulsion was stable. Results are reported in Table 3.

TABLE 3
Stabilizing Effect of Condensation Product

| Condensation | | | | | |
|---|---|---|---|---|---|
| Product | Time (hours) | | | | |
| Concentration | 1 | 2 | 4 | 10 | 24 |
| 1 wt. % | Stable | Stable | Not stable | Not stable | Not stable |
| 2 wt. % | Stable | Stable | Not stable | Not stable | Not stable |
| 3 wt. % | Stable | Stable | Semi-stable | Not stable | Not stable |
| 4 wt. % | Stable | Stable | Stable | Not stable | Not stable |

As shown in Table 3, across all concentrations, the condensation product maintained a stable solution for at least 2 hours. As the concentration increased, the stability of the emulsion also increased. These results indicate that condensation product, particularly at higher concentrations, suitably emulsifies a water-in-oil emulsion typical of the drilling fluid compositions.

### Embodiments

The following embodiments are contemplated. All combinations of features and embodiments are contemplated

Embodiment 1: A drilling fluid composition, comprising: from 0.1 wt. % to 10 wt. % of a condensation product of a trifunctional amine and a fatty acid, wherein the weight ratio of the trifunctional amine to the fatty acid in the condensation product ranges from 0.1:1 to 10:1; and an oil base fluid.

Embodiment 2: an embodiment of embodiment 1, wherein the weight ratio of the trifunctional amine to the fatty acid in the condensation product is from 0.3:1 to 2:1.

Embodiment 3: an embodiment of embodiment 1 or 2, wherein the drilling fluid composition demonstrates a plastic viscosity greater than 15 cP at 25° C.

Embodiment 4: an embodiment of any one of embodiments 1-3, wherein the drilling fluid composition demonstrates a plastic viscosity greater than 10 cP at 80° C.

Embodiment 5: an embodiment of any one of embodiments 1-4, wherein the drilling fluid composition demonstrates a yield point greater than 15 lb/100 ft² at 25° C.

Embodiment 6: an embodiment of any one of embodiments 1-5, wherein the drilling fluid composition demonstrates a yield point greater than 10 lb/100 ft² at 80° C.

Embodiment 7: an embodiment of any one of embodiments 1-6, wherein the drilling fluid composition demonstrates a ratio of yield point to plastic viscosity less than 2.

Embodiment 8: an embodiment of any one of embodiments 1-7, further comprising a viscosity modifier, a pH modifier, a density modifier, a filtration modifier, an aqueous component, a shale inhibitor, or combinations thereof.

Embodiment 9: an embodiment of any one of embodiments 1-8, wherein the oil base fluid comprises a diesel oil, a mineral oil, a linear olefin, a linear paraffin, or combinations thereof.

Embodiment 10: an embodiment of any one of embodiments 1-9, wherein the trifunctional amine comprises from 6 to 12 carbon atoms.

Embodiment 11: an embodiment of any one of embodiments 1-10, wherein the trifunctional amine has a chemical formula

CₓH_{y}(NH₂)₃,
wherein x is from 6 to 12; and
wherein y is less than or equal to 23.

Embodiment 12: and embodiment of any one of embodiments 1-11, wherein the

fatty acid comprises palmitic acid, oleic acid, linoleic acid, abietic acid, sapienic acid, palmitoleic acid, myristoleic acid, elaidic acid, vaccenic acid, or tall oil, isomers thereof, or combinations thereof.

Embodiment 13: a process for preparing a drilling fluid composition, comprising:
reacting a trifunctional amine and a fatty acid at a temperature of at least 100° C. for at least 10 hours to form a condensation product; and
adding the condensation product to an oil base fluid to form the drilling fluid composition;
wherein the condensation product comprises less than 15 wt. % impurities.

Embodiment 14; an embodiment of embodiment 13, further comprising adding a viscosity modifier, a pH modifier, a density modifier, a filtration modifier, an aqueous component, a shale inhibitor, or combinations thereof to the oil base fluid.

Embodiment 15: an embodiment of embodiment 13 or 14, wherein the oil base fluid comprises a diesel oil, a mineral oil, a linear olefin, a linear paraffin, or combinations thereof.

Embodiment 16: an embodiment of embodiments 13-15, wherein the trifunctional amine comprises from 6 to 12 carbon atoms.

Embodiment 17: an embodiment of embodiments 13-16, wherein the trifunctional amine has a chemical formula

CₓH_{y}(NH₂)₃,
wherein x is from 6 to 12; and
wherein y is less than or equal to 23.

Embodiment 18: an embodiment of embodiments 13-17, wherein the fatty acid comprises palmitic acid, oleic acid, linoleic acid, abietic acid, sapienic acid, palmitoleic acid, myristoleic acid, elaidic acid, vaccenic acid, or tall oil, isomers thereof, or combinations thereof.

1.-20. (canceled)

21. A process of drilling a wellbore, the process comprising:
disposing into the wellbore a drilling fluid composition comprising from 0.1 wt. % to 10 wt. % of a condensation product of a trifunctional amine and a fatty acid and an oil base fluid;
wherein the weight ratio of the trifunctional amine to the fatty acid in the condensation product ranges from 0.1:1 to 10:1.

22. The process of claim 21, wherein the weight ratio of the trifunctional amine to the fatty acid in the condensation product is from 0.3:1 to 2:1.

23. The process of claim 21, wherein the condensation product corresponds to Formula 1: 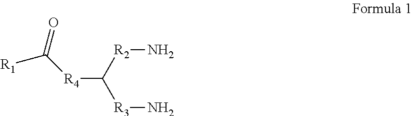
wherein R₁ is an alkyl group, alkene group, or alkyne group of 8 to 24 carbons,
R₂ is an alkyl group, alkene group, or alkyne group of 1 to 10 carbons,
R₃ is an alkyl group, alkene group, or alkyne group of 1 to 10 carbons,
R₄ is an amino group of 1 to 10 carbons.

24. The process of claim 21, wherein the condensation product corresponds to Formula 2b:

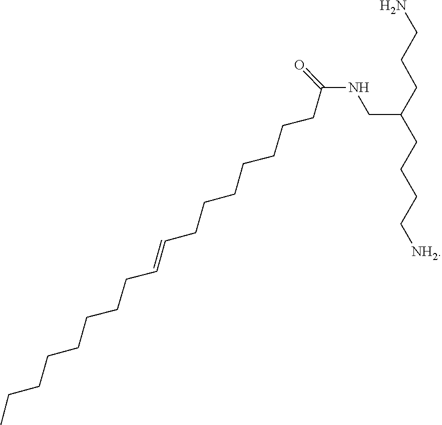 [SMILES: CCCCCCCC/C=C/CCCCCCCC(=O)NCC(CCCN)CCCCN]

25. The process of claim 21, wherein the drilling fluid composition demonstrates a plastic viscosity greater than 15 cP at 25° C.

26. The process of claim 21, wherein the drilling fluid composition demonstrates a plastic viscosity greater than 10 cP at 80° C.

27. The process of claim 21, wherein the drilling fluid composition demonstrates a yield point greater than 15 lb/100 ft² at 25° C.

28. The process of claim 21, wherein the drilling fluid composition demonstrates a yield point greater than 10 lb/100 ft² at 80° C.

29. The process of claim 21, wherein the drilling fluid composition demonstrates a ratio of yield point to plastic viscosity less than 2.

30. The process of claim 21, further comprising a viscosity modifier, a pH modifier, a density modifier, a filtration modifier, an aqueous component, a shale inhibitor, or combinations thereof.

31. The process of claim 21, wherein the oil base fluid comprises a diesel oil, a mineral oil, a linear olefin, a linear paraffin, or combinations thereof.

32. The process of claim 21, wherein the trifunctional amine comprises from 6 to 12 carbon atoms.

33. The process of claim 21, wherein the trifunctional amine has a chemical formula
CₓH_{y}(NH₂)₃,
wherein x is from 6 to 12; and
wherein y is less than or equal to 23.

34. The process of claim 21, wherein the fatty acid comprises palmitic acid, oleic acid, linoleic acid, abietic acid, sapienic acid, palmitoleic acid, myristoleic acid, elaidic acid, vaccenic acid, or tall oil, isomers thereof, or combinations thereof.

35. A process for drilling oil and gas, the process comprising:
disposing into a wellbore a drilling fluid composition comprising from 0.1 wt. % to 10 wt. % of a condensation product of a trifunctional amine and a fatty acid and an oil base fluid;
wherein the weight ratio of the trifunctional amine to the fatty acid in the condensation product ranges from 0.1:1 to 10:1.

36. The process of claim 35, wherein the condensation product corresponds to Formula 1: 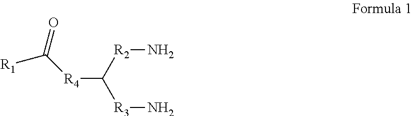
wherein R₁ is an alkyl group, alkene group, or alkyne group of 8 to 24 carbons,
R₂ is an alkyl group, alkene group, or alkyne group of 1 to 10 carbons,
R₃ is an alkyl group, alkene group, or alkyne group of 1 to 10 carbons,
R₄ is an amino group of 1 to 10 carbons.

37. The process of claim 35, wherein the drilling fluid composition demonstrates a plastic viscosity greater than 15 cP at 25° C.

38. A process of for drilling oil and gas, the process comprising:
disposing into a wellbore a drilling fluid composition comprising from 0.1 wt. % to 10 wt. % of a condensation product of a trifunctional amine and a fatty acid and an oil base fluid;
wherein the condensation product forms a stable emulsion.

39. The process of claim 38, wherein the drilling fluid composition demonstrates a plastic viscosity greater than 15 cP at 25° C.

40. The process of claim 38, wherein the condensation product corresponds to Formula 1: 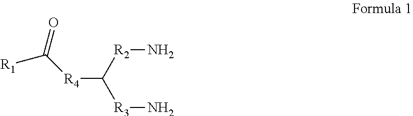
wherein R₁ is an alkyl group, alkene group, or alkyne group of 8 to 24 carbons,
R₂ is an alkyl group, alkene group, or alkyne group of 1 to 10 carbons,
R₃ is an alkyl group, alkene group, or alkyne group of 1 to 10 carbons,
R₄ is an amino group of 1 to 10 carbons.
